(19) United States
(12) Patent Application Publication
(10) Pub. No.: US 2023/0020163 A1
(43) Pub. Date: Jan. 19, 2023

(54) REMOTELY-MANAGED, DATA-SIDE DATA TRANSFORMATION

(71) Applicant: Protopia AI, Inc., Austin, TX (US)

(72) Inventor: Hadi Esmaeilzadeh, Austin, TX (US)

(21) Appl. No.: 17/865,273

(22) Filed: Jul. 14, 2022

Related U.S. Application Data
(60) Provisional application No. 63/221,738, filed on Jul. 14, 2021.

(51) Int. Cl. G06F 13/36

(52) U.S. Cl. CPC G06F 13/36

(57) ABSTRACT

Provided is a system, comprising: a computing device, comprising: computational storage or computational memory, the computational storage or computational memory having a processor; a downstream data processor that is different from the processor of the computational storage or computational memory; and a bus connecting the processor to the computational storage or computational memory, wherein the computing device comprises a tangible, non-transitory, machine readable medium storing instructions that, when executed, effectuate operations comprising: receiving an input from a remote device conveyed to the computing device; determining, based on the input, how to configure a transformation of data stored in the computational storage or computational memory; and applying, with the processor, the configured transformation to the data stored in the computational storage or computational memory; and outputting the transformed data to the downstream data processor.

### CROSS-REFERENCE TO RELATED APPLICATIONS

This application claims the benefit of U.S. Provisional Application 63/221,738, titled “REMOTELY-MANAGED, NEAR-STORAGE OR NEAR-MEMORY DATA TRANSFORMATIONS,” filed 14 Jul. 2021, the entire contents of which is hereby incorporated by reference.

### BACKGROUND

Computers generally include a central processing unit, storage, and memory. The latter two components often store data upon which the CPU operates. In some cases, it may be desirable for a computational entity to remotely manage what data in the memory or storage the CPU can access and, in particular, to apply such management with relatively fine granularity, in some cases, at the sub-data-record level on unstructured data.

### SUMMARY

The following is a non-exhaustive listing of some aspects of the present techniques. These and other aspects are described in the following disclosure.

Some aspects include a system, comprising: a computing device, comprising: computational storage or computational memory, the computational storage or computational memory having a processor; a downstream data processor that is different from the processor of the computational storage or computational memory; and a bus connecting the processor to the computational storage or computational memory, wherein the computing device comprises a tangible, non-transitory, machine readable medium storing instructions that, when executed, effectuate operations comprising: receiving an input from a remote device conveyed to the computing device; determining, based on the input, how to configure a transformation of data stored in the computational storage or computational memory; and applying, with the processor, the configured transformation to the data stored in the computational storage or computational memory; and outputting the transformed data to the downstream data processor.

Some aspects include a tangible, non-transitory, machine-readable medium storing instructions that when executed by a data processing apparatus cause the data processing apparatus to perform operations of the above-mentioned system.

Some aspects include a method, including operations of the above-mentioned system.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows a data device comprising a data-side processor which implements a remotely-managed data transform, in accordance with some embodiments;

FIG. 2 illustrates an exemplary method for application of a remotely-managed, data-side transform, in accordance with some embodiments;

FIG. 3 shows an example computing device containing a data-side processor, according to some embodiments; and

FIG. 4 shows an example computing system that may be used in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the fields of machine learning and computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

As the ability to acquire and store data increases, data science has developed algorithms, systems, architectures, etc., which may extract (e.g., infer) useful insights from larger and larger amounts of data. The rate of data generation, and commensurate storage (both long-term and short-term), has increased at an overwhelming rate, where the computational abilities of computing systems to process such massive data stores has not necessarily kept up. For example, it has been predicted that at the beginning of 2020, the amount of data in the world amounted to 44 zettabytes, while the expectation is that by 2025, 463 exabytes will be generated every day globally. Data may be stored in long-term storage (e.g., data storage) and/or short-term storage (e.g., memory). Herein, “data store” refers to an element for storing of data without regard to length of storage time, latency, etc., and type of media, including magnetic media, RAM, etc. Data stores includes data storage, memory, long-term data storage, short-term data storage, etc.

A data store which includes a computational device (e.g., processor) may be used to bridge a divide between data and computing. Data-side computing (e.g., computing performed proximate to the data store) may be used to reduce the quantity of data sent downstream to further computational processes, to protect vulnerable data elements, to pre-compute features, etc. Data-side computing may be performed on a computing element integrated into a data store, such as within a security envelope of the data store. For example, data-side computing may be performed on a computing element integrated into a data store (e.g., data storage, memory, etc.) such as through use of homogeneous integration or heterogeneous integrations (e.g., chiplet packaging), without interacting with other computing elements (e.g., a bus, a network connection, etc.).

In some embodiments, data from storage may be processed at the data-side computing device before being shipped to an additional computing element—where the additional computing element may be a computing element of a computing system containing the data store, computing elements in a cloud, computing elements of another computing system, etc. where more processing may be performed. In some embodiments, data processing may be divided into two stages: (1) data-side and (2) downstream. The type of data-side processing may depend on multiple factors, including, but not limited to, the nature (e.g., secured, unsecured, etc.) and type (e.g., motion detection, inference, etc.) of the downstream processing. For example, the type or nature of the downstream task may effect the amount, security, type, etc. of the data which is transferred to the downstream processing. For example, which user is requesting data (e.g., a secure user, a non-secure user, etc.), which platform is going to perform the downstream task (e.g., a central processing unit (CPU) of the computing device, a cloud-based service, etc.), and other factors can effect the data-side processing. In some embodiments, the data-side processing may be consistent. In other embodiments, the data-side processing may be adjusted based on the downstream task. In some embodiments, a control input may be acquired by the data-side processing, such as based on the identity of the downstream task, and the data-side processing may be adjusted based on the control input. In some embodiments, the data-side processing may comprise a control plane (e.g., a control knob) which may be used to adjust elements of the data-side processing applied to the data of the data store.In some embodiments, a cloud-managed data-side data transformation is implemented. A could service may determine which data of the data store is selected and/or determine which data transformation is applied by the data-side processing to the data of the data store. In some embodiments, data-side processing may be applied to the data before it is transmitted from the data store to a cloud service. In some embodiments, the cloud service may determine what data-side processing is applied to the data before it is transmitted out of the data store. The cloud service may be any other computational entity (e.g., a non-cloud service, an additional processing device, etc.) which is separate from the processor which performs the data-side processing. The cloud service may instead be another data store, including a data store incorporating data-side processing. Two or more data stores with data-side processing capabilities may be linked, in series or parallel, including such that data which has been transformed by data-side processing may be stored in another data store and may even have additional data-side processing, performed by the same or another data-side processer, performed on it.

The cloud-managed data-side data transformation may instead or additionally be a remotely-managed data-side transformation. In some embodiments, a remotely-managed data-side transform is implanted. A remote computing device, such as a processor with or without associated memory, storage, input/output device, etc., may determine which data of the data store is selected and/or determine which data transformation is applied by the data-side processing to the data of the data store. The remote computing device may or may not correspond to a cloud service. In some embodiments, the remote computing device may acquire the data output by the data-side processing device. In some embodiments, the remote computing device may provide input to the data-side processing, but may not receive the data output by the data-side processing device.

In some embodiments, the data-side processing may generate multiple sets of data for output, which may be output to different devices, including different stages of a data pipeline. In some embodiments, the data-side processing may generate multiple sets of data, which may include obfuscated (e.g., de-identified) data and obfuscated data. The data-side processing may generate multiple data sets, which are output by both secure means (e.g., to processors within a security envelope) and by unsecured means (e.g., to processors outside a security envelope). In some embodiments, the data-side processing may output data by secure means to parts of a data pipeline and output the same or different data by unsecured means to different parts of the same or a different data pipeline. In some embodiments, secured and unsecured data may be reconstituted at one or more secured processes in the data pipeline.

The data transforms implemented by the data-side processing may be any appropriate transforms. The data transforms implemented by the data-side processing may be adjustable in both type and strength. For example, data-side processing may implement data sampling of adjustable strength. The data-side processing may be adjustable such that the sampling size can be adjusted from null (e.g., zero samples in the subsample) to full (e.g., all samples of the data store in the subsample). The data-side processing may be adjusted by a remote computing device (e.g., a cloud service) based on the data needs, security, processing power, etc. of the downstream processor to which the transformed data is output. In another example, data-side processing may implement data sampling or may implement another transform—such as obfuscation. The type of the data transform may be adjustable, such as based on input from the remote computing device. For example, the data-side processor may output subsamples of the data of the data store for one output device and may output obfuscated data of the data store for another output device. Various transforms may be performed by the same or different elements of the data-side processor. The data store may include multiple data-side processors, in series or in parallel, which may be selected based on input from the remote computing device.

In some embodiments, transforms may be applied in series or in parallel to data of the data store to generate one or more set of output data. For example, data of the data store may be both sampled and obfuscated. The data-side processor may apply an ensemble of transforms, where the combination of transforms in various orders and combinations may generate new transforms.

Examples of various data-side processing transforms include, but are not limited to, sampling, obfuscating, nullifying, feature extraction, processing by a neural network, data governance application, etc. The data-side processor may include instructions to perform one or more data transformation, and may apply those instructions based on input from a remote computing device. The input from the remote computing device may be an integer, a string, a vector, a command, programming, etc. The data-side processor may be pre-programmed with a machine learning model, including a neural network, a decision tree, a vector machine, etc. The data-side processor may be programmable, based on instructions from the remote computing device. The data-side processor may not be programmable based on instructions from the remote computing device, but may be programmable based on instructions from another device, such as a device with which the data store may securely communicate. The data side-processor may be programmed, for example, by a machine learning algorithm, and may be unprogrammable as deployed. The data-side processor may be undatable, such as by introduction of additional training, or retrainable.

In some embodiments, the data-side processor may perform sampling (including subsampling). The data-side processor may perform sampling, subsampling, etc. based on communication from the remote computing device. The data-side processor may sample based on a data feature, randomly, based on a machine learning model, etc. The data-side processor may adjust a sampling rate. The data-side processor may identify duplicate records or perform other data clean processes before sampling. The data-side processor may perform sampling based on acceptable data size for a downstream process.

In some embodiments, the data-side processor may perform data obfuscation. The data-side processor may perform obfuscation based on communication from the remote computing device. The data-side processor may perform obfuscation based on identification of vulnerable data, for example personally identifying data, and may obfuscate instances of vulnerable data. The data-side processor may perform obfuscation based on both programming which identifies vulnerable data and based on input from the remote computing device. The data-side processor may adjust a privacy value for obfuscation, such as a differential privacy value E. The data-side processor may adjust the privacy value based on input from the remote computing device or infer a privacy value based on input from the remote computing device. The data-side processor may adjust a privacy value based on the type of data requested or the output to which the data will flow. For example, the data-side processor may apply obfuscation with a first privacy value for data flowing to a trusted output and apply obfuscation with a second privacy value for data flowing to a unknown or untrusted output.

In some embodiments, the data-side processor may perform data nullification. The data-side processor may perform nullification based on communication from the remote computing device. The data-side processor may perform data nullification on a subsample of data—such as data corresponding to a specific class of user. The data-side processor may perform data nullification by outputting null data. The data-side processor may also or instead perform data nullification by outputting nonsense data—such as random or pseudo-random data. The data-side processor may output data to an untrusted output which is nullified, but which does not immediately alert the untrusted output that the data-side processor is providing nullified data. The data-side processor may instead output an alert to an untrusted output, for example one which may alert the untrusted output to update a setting in order to become a trusted output. The data-side processor may be adjusted to output a variety of different nullified datasets—an empty set, an obfuscated set in which data is heavily obfuscated, a preprogrammed null set (for example, lorem ipsum text), a dataset with one or more nullified subsamples, a dataset with one or more nullified categories, etc.

In some embodiments, the data-side processor may perform additional processing, such as machine learning processing, on the data. The data-side processor may perform part of a process, in which the rest of the process may be performed by downstream processing. For example, the data-side processor may apply a few layers of a neural network to data of the data store, and then output the output of the neural network layers to a downstream processor, which may perform further processing based on other layers of the same or a different neural network. The data-side processor may apply a machine learning algorithm which is part of an ensemble of machine learning algorithms of a data pipeline. The data-side processor may apply a machine learning algorithm, and then make a determination about the output of the machine learning algorithm. The data-side processor may determine that the output for the machine learning algorithm is to be output to one or more processors of the data pipeline, which may include other machine learning algorithms. The data-side processor may also determine that the output of the machine learning algorithm is not to be output to the one or more processors of the data pipeline. The data-side processor may adjust the machine learning algorithm based on input from the remote computing device.

For example, the data-side processor can apply an algorithm to security camera data which determines if movement is present. If no movement is present, the data may remain in the data store (or be purged from the data store). If movement is detected, the data-side processor may output the data to a downstream processor of the data pipeline. The data-side processor may obfuscate the data before outputting, or apply other appropriate techniques. In such a way, part of a machine learning algorithm may be applied to secure data (e.g., data within a security envelope) to determine if such data is to be output to downstream processing, which may be outside the security envelope. The data which is output may be identified as already containing data on which a machine learning algorithm can operate (such as make an inference). The output data may be obfuscated or otherwise have features stripped from it which are not to be exposed to unsecured processors, but which may be helpful or necessary for processing by the data-side processor machine learning algorithm.

In some embodiments, the data-side processor may apply a set of data governance algorithms (e.g., rules). The data governance algorithm may be controlled by input from the remote computing device. The data governance algorithm can be governed by a set of rules (e.g., internally consistent rules) which determine which data can be provided to which downstream processors. For example, the data governance algorithm can have three possible outputs: (1) data nullification, (2) data transformation, and (3) data output. The data-side processor or the remote computing device can determine if the data of the data store should be nullified before being output—such as if the data is corrupted. The data-side processor or the remote computing device can determine if the data should be transformed—such as if the data is being sent outside of the security envelope. The data-side processor or the remote computing device can determine if the data should be output as is, with out a transform being applied, such as if the data is being sent within the security envelope. In such as case, an identify transform can be applied, such that the transformed data is substantially identical to the data of the data store.

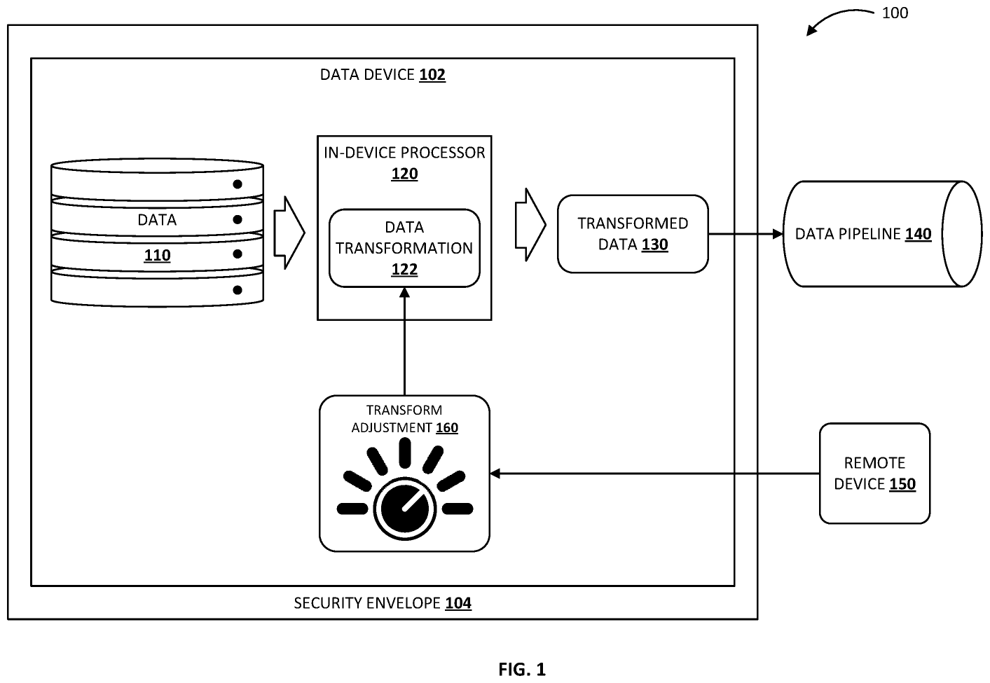

FIG. 1 shows a data device comprising a data-side processor which implements a remotely-managed data transform. FIG. 1 depicts a schematic 100 showing a data device 102. The data device 102 may be a data storage device (or other long-term storage device). The data device 102 may be a memory device (or other shot-term storage device). The data device 102 may de a data store, as previously described. The data device 102 may contain data 110. The data 110 may be stored in any appropriate format, such as magnetic storage, optical storage, solid state storage, cache memory, random access memory (RAM), dynamic RAM (DRAM), static RAM (SRAM), synchronous DRAM (SDRAM), read only memory (ROM), etc. The data device 102 may contain an in-device processor 120. The in-device processor 120 may be any appropriate type of processor. The in-device processor 120 may be homogeneously integrated with (e.g., within) the data 110 store. The in-device processor 120 may be heterogeneously integrated with the data 110 store, such as via chiplet integration. The in-device processor 120 may be connected via a bus or other communication device with the data 110 store. The data device 102 may be within a security envelope 104, where the data device 102 may contain data 110 which is not accessible to devices outside of the security envelope 104. The data 110 and the in-device processor 120 may be inside of the security envelope 104. The data 110 store may acquire data, such as via a one-way transaction, from a device outside of the security envelope 104—such as a wireless camera. Alternatively, the data 110 store may acquire data via a device which is inside of the security envelope 104, such as a wired camera. The data 110 may comprise data acquired from less secure means, such as data transmitted in encrypted format over a secure or unsecure network. The data 110 may comprise such data in an encrypted or unencrypted format. The in-device processor 120 may communicate with devices outside of the security envelope, such as via a one-way transmission of transformed data 130. The in-device processor 120 may also or additionally receive input from a remote device 150, including via a transform adjustment 160.

The in-device processor 120 may comprise instructions (e.g., code) for performing one or more transform on the data 110. The in-device processor 120 may perform a transform on data 110 as it is requested, such as by the remote device 150, and/or as it is transmitted, such as to a data pipeline 140. The in-device processor 120 may comprise one or more processor, memory, storage, etc. The in-device processor 120 may comprise one or more processor and access information stored with the data 110. The in-device processor 120 may perform one or more data transformation 122. The data transformation 122 may be any appropriate transformation, including a partial transformation, series of transformations, iterative transformations, etc. The in-device processor 120 may output the transformed data 130, which may be produced by the data transformation 122 operating on the data 110, to storage within the data device 102 or to storage or devices outside of the data device 102, including outside of the security envelope 104. The data transformation 122 may be adjusted (e.g., in type, strenghth, output size, etc.) by a transform adjustment 160. The data transformation 122 may have a default setting, such that a baseline data transformation 122 is performed if no input from the transform adjustment 160 is received. The data transformation 122 may also or instead operate on a push basis, such that the data transformation 122 occurs when information is received from the transform adjustment 160—such as a data request. The transform adjustment 160 can specific a type of transform, strength of transform, etc. The transform adjustment 160 can comprise a set of data governance rules (e.g., decision trees) which can adjust the data transformation 122 based on input from the remote device 150.

The remote device 150 can be a central processing unit, such as of a computing device. The remote device 150 can be a cloud device, such as a cloud service device, or in communication with a cloud service. The data pipeline 140 can include the remote device 150. The data pipeline 140 can instead be distinct from the remote device 150. The data pipeline can be a central processing unit, such as of a computing device which contains the data device 102. The data pipeline can include one or more cloud service.

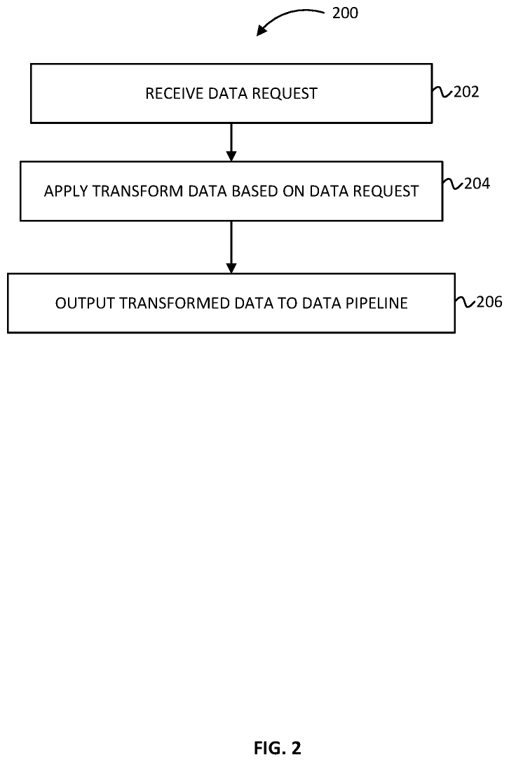

FIG. 2 illustrates an exemplary method 200 for application of a remotely-managed, data-side transform. Each of these operations is described in detail below. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting. In some embodiments, one or more portions of method 200 may be implemented (e.g., by simulation, modeling, etc.) in one or more processing devices (e.g., one or more processors). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200, for example.

At an operation 202, a data request is received. The data request may be received at a data-side processor via a remote computing device. The data request may include the type of data to be output, the transform to be applied to the data, the size of data to be output, and other appropriate information about the data request. Any part of the data request may instead be pre-programmed at the data-side processor. For example, the data-side processor may output data of a certain size at certain intervals. The data request may identify a data output location. The data request may indicate a type of transform to be applied to the data, a strength of transform to be applied to the data, etc. If the data-side processing includes a machine learning algorithm, the data request may include weights for nodes of the machine learning algorithm. The data request may be split between input from a remote computing device and preprogrammed instructions of the data-side processor.

At an operation 204, a transform is applied to data based on the data request. The transform may be applied to substantially all (e.g., all, most, almost all, all uncorrupted data, all data in the most recent time interval, etc.) data of the data store. The transform may be applied to a subset of the data of the data store. The transform may comprise multiple transforms which may be applied to the same or different subsets of the data of the data store. The transform may comprise an ensemble of transforms. The transform may include an identity transform, nullification, obfuscation, sampling, etc. The transform may include application of all or part of a machine learning algorithm, including a neural network, a decision tree, etc. The transform may include a mathematical application, such as a linear regression. The transform may be any appropriate transform as previously described.

At an operation 206, the transformed data is output to the data pipeline. The data pipeline may comprise a central processing unit, a cloud service, additional processors, etc. The data pipeline may or may not communicate with the remote computing device which provides the data request. The data pipeline may include unsecured processors or be outside of a security envelope of the data tore.

As described above, method 200 (and/or the other methods and systems described herein) is configured to provide a generic framework for a data-side processor. The data-side processor may provide data processing and/or transformation at the data store.

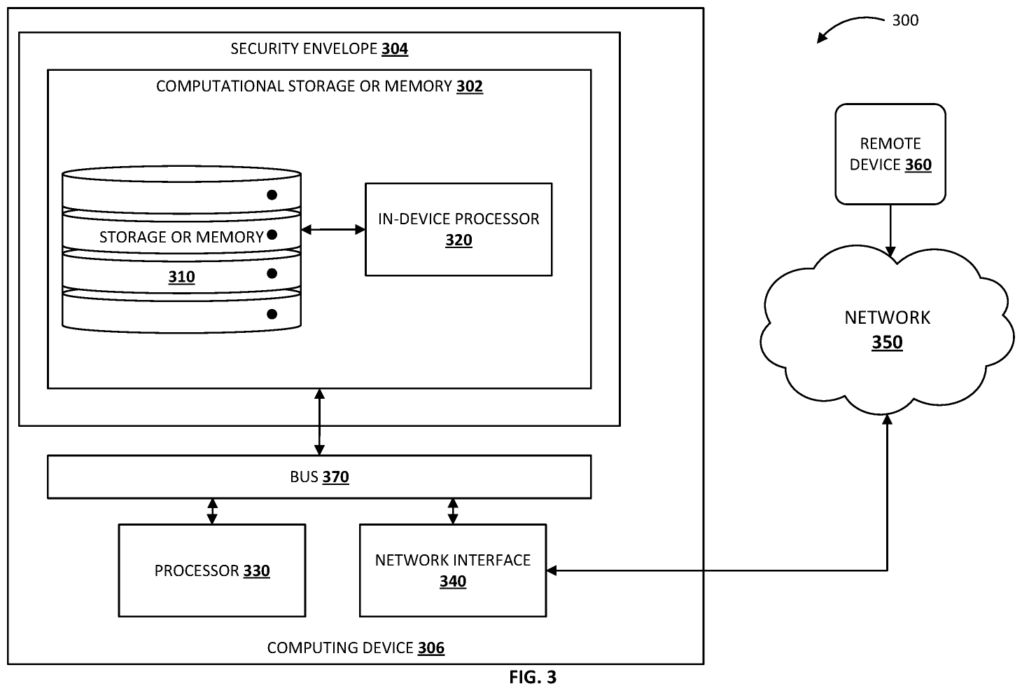

FIG. 3 shows an example computing device containing a data-side processor. FIG. 3 depicts a schematic 300 showing a computing device 306. The computing device 306 may comprise a computational storage or memory 302. The computing device 306 may comprise at least one of a computational storage as described by the computational storage or memory 302, a memory as described by the computational storage or memory 302, or a combination of both. The computational storage or memory 302 may comprise a storage or memory 302 and an in-device processor 320. The computational storage or memory 302 may be within a security envelope 304. The computational storage or memory 302 may be controlled by a processor 330, which may be a central processing unit of the computing device 306. The processor 330 and the computational storage or memory 302 may communicate over a network, bus, etc. The processor 330 may communicate with a network 350 via a network interface 340. The network 350 may allow communication between a remote device 360 and the computing device 306, such as facilitated by the network interface 340.

The remote device 360 may execute control over the computing device 306, including the in-device processor 320 via the network 350, the network interface 340, and the processor 330. In some embodiments, the remote device 360 and the computing device 306 may be geographically remote, for instance on different subnetworks, physically separated by more than 1 km, 100 km, or 1000 km. In some embodiments, the remote device 360 is a cloud service. In some embodiments, the remote device 360 and the computing device 306 are in the same subnetwork, such as in the same data center, or different data centers of the same subnetwork. The network 350 may be a local area network, a larger network such as the internet (with or without secured access such as a virtual private network (VPN),

In some embodiments, the network interface 340 may interface between the processor 330 and the network 350. In some embodiments, the techniques described herein as being performed by the processor 330 may also be performed by a similar processor on the network interface 340 for either inbound or outbound data, or such a processor 330 may be in a similar arrangement in a data source, like a camera, microphone, LIDAR, medical imaging device, or the like.

In some embodiments, the computational storage or memory 302 may be computational storage in the form of a solid-state drive, like a solid-state flash drive, for instance, or in a hard disk drive. In some embodiments, the computational storage or memory 302 may be computational memory, like computational random-access memory, such as computational dynamic random-access memory or persistent system memory. Computational memory and storage are distinct from the non-computational versions thereof in virtue of the in-device processor 320 with which they are integrated in the various manners described below.

In some embodiments, the computational storage or memory 302 may include a in-device processor 320 and storage or memory 310. The data stored by the computing device 306 may be stored in the storage or memory 310, for instance in flash chips, on hard disks, in dynamic random-access memory chips, or the like. In some embodiments, this data may be written to the storage or memory 310 by the processor 330, or the computational storage or memory 302 may be provided for installation in the computing device 306 with that information already stored. In some embodiments, that information may be provided to the processor 330 via the network 350 in encrypted form and only decrypted by the in-device processor 320, for instance, with an encryption key stored therein and inaccessible to the processor 330, such that the processor 330 does not have access to the plain text version of the stored data. In some cases, such keys may be managed by a secure enclave having another co-processor that is distinct from the processor 330 in a similar manner.

In some embodiments, the in-device processor 320 may execute relatively fine-grained control over access by the processor 330, and access by the applications executing in the operating system executed thereon, to the data stored in the storage or memory 310. In some cases, this control may be managed by the remote device 360, for instance, responsive to application program interface request sent by an application executing on the remote device 360. Examples of such control include the various types of transformations described herein. In some cases, the data may be transformed in the manner described by the in-device processor 320 before the resulting transformed data is provided to the processor 330, without the processor 330 having access to the untransformed version of the data. In some cases, this may help protect that data from compromised applications executed by the processor 330 or inspection by threat actors. In some cases, the in-device processor 320 may execute branching logic to determine which transformation to apply based on an identifier or indicia of authorization or authentication provided with the request from an application, and those parameters may be provided by the remote device 360.

In some embodiments, the in-device processor 320 may be a field programmable gate array implementing the described logic, an application specific integrated circuit having the described logic encoded thereon (and thus serving as a type of tangible, non-transitory, machine-readable medium), or a separate microprocessor having a distinct arithmetic logic unit and physical memory address space from the processor 330. In some embodiments, the operations of the in-device processor 320 may include executing code stored in memory (for instance memory of the storage or memory 310 or other memory) that cause the in-device processor 320 to perform the described operations. In some cases, the in-device processor 320 may communicate with the processor 330 via interrupts and various registers or areas of system memory in a virtual address space of a driver of the in-device processor 320 executed by an operating system run on the processor 330.

In some embodiments, the in-device processor 320 may communicate with the remote device 360 directly via the network interface 340 or other hardware, like a separate network interface card in a baseboard management controller. Or in some cases, communications to the in-device processor 320 from the remote device 360 may pass through processes controlled by the processor 330 and a network stack of an operating system executing thereon.

In some embodiments, the in-device processor 320 may requests instructions that configure transformations from the remote device 360 responsive to data access requests from an identified (e.g., by the request) application executing on the processor 330, or in some cases, the remote device 360 may send such instructions in advance of such requests.

In some embodiments, the in-device processor 320 may execute a process that implement relatively fine-grained control over which information stored in the storage or memory 302 is accessible to the processor 330. In some cases, this may include masking or otherwise filtering designated fields (for instance designating the command from a remote device 360) in structured data stored in the storage or memory 310 and requested by the processor 330. In some cases, masking may include replacing those fields with a null value or deleting those fields. In some cases, the transformation may include injecting noise into those fields, for instance by sampling from a noise distribution designated in a command from the remote device 360 (or conditional on which application is requesting data as specified by such a command) to implement differential privacy techniques.

In some embodiments, the data stored by the storage or memory 310 may be unstructured data, and the in-device processor 320 may limit access by the processor 330 to various sub-data record units of information in that unstructured data. Examples include masking, filtering, or injecting noise into various features at intermediate layers in a neural network, for instance, by implementing some number (for instance one, two, or more,) upstream layers of a neural network in the in-device processor 320 and then masking or filtering or injecting noise into the intermediate outputs of those layers before they are provided to the processor 330 to be input into downstream layers of the neural network. Other examples include modifying, masking, filtering, or otherwise changing scalar values in dimensions of vectors in embedding spaces output by encoders, modifying in a similar manner dimensions upon which decision trees or classification trees executed by the processor 330 split, or applying similar transformations to various statistical characterizations of the stored data, like measures of central tendency, such as mean, median, or mode, or measures of variation, such as standard deviation, variance, kurtosis, or the like. In some cases, the in-device processor 320 may sub-sample requested data (for instance at a rate specified by the remote device 360 or on fields specified by that remote device 360) or inject additional random data among that requested.

In some cases, the in-device processor 320 may rate limit or limit a number of times in which data is accessed by the processor 330 (or a designed application) to impede attacks in which noise injected by the in-device processor 320 is removed through repeated sampling and application of the central limit theorem.

Although the in-device processor 320 and processor 330 are both described as processors, these may be co-processors. The processor 330 is not required to be the primary processor and the in-device processor 320 a secondary processor—in some embodiments the in-device processor 320 may be the dominant processor, the processors may be of equal dominance, etc.

In some embodiments, the transformations happen within the computational storage or memory 302, before transformed results are communicated back to the processor, such as via a bus 370. The bus 370 may take a variety of forms, depending upon the type of storage or memory and use by computing device 306. In some embodiments, the bus 370 is a dynamic random access memory bus, like a DDR3, DDR4, or DDR5 bus specified by the corresponding JEDEC standards. In some embodiments, the bus 370 is a PCI express 3, 4, or 5 bus. In some embodiments, the in-device processor 320 sits on the bus 370 between the storage or memory 310 and the processor 330, or in some cases, the in-device processor 320 sits on the same interposer, printed circuit board, or monolithic body of semi conductive material forming storage or memory 310 and transforms the data before the data is put on the bus 370.

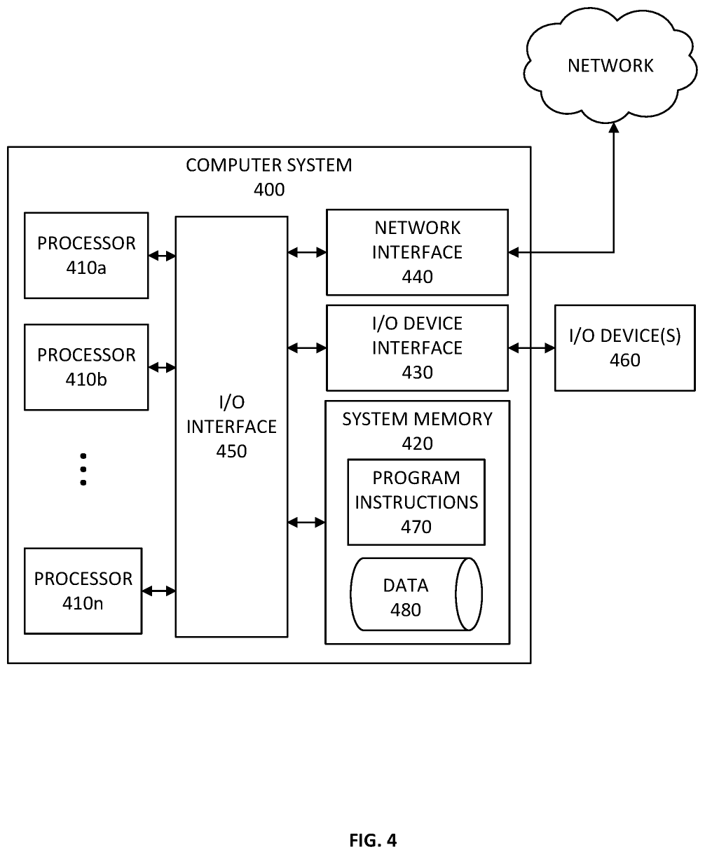

FIG. 4 shows an example computing system that may be used in accordance with some embodiments.

In some embodiments, techniques and devices like those described above (and related approaches) may be implemented with the data device 102 illustrated in FIG. 1. In some embodiments, techniques and devices like those described above (and related approaches) may be implemented with the computing device 306 illustrated in FIG. 3. In some embodiments, techniques and devices like those described above (and related approaches) may be implemented with the computing system 400 illustrated in FIG. 4. In some embodiments, each of these devices may include a tangible, non-transitory, machine-readable medium storing instructions that when executed effectuate the described functionality. In some embodiments, this medium may be the same as the described computational storage or memory or different bodies of memory or storage.

In some embodiments, the transformation is the application of noise described in U.S. Provisional Application 62/986,552 titled “METHODS OF PROVIDING DATA PRIVACY FOR NEURAL NETWORK BASED INFERENCE” filed on Mar. 6, 2020, or in U.S. Provisional Application 63/153,284 titled “METHODS AND SYSTEMS FOR SPECIALIZED DATASETS FOR TRAINING/VALIDATION OF MACHINE LEARNING,” filed on Feb. 24, 2021, the contents of each or which are hereby incorporated by reference.

In some embodiments, the transformation is the application of stochastic noise. Examples of transforms, including stochastic noise and obfuscation transforms, that may be used are described in U.S. Provisional Patent Application 63/227,846, titled “STOCHASTIC LAYERS”, filed 30 Jul. 2021; U.S. patent application Ser. No. 17/680,108 titled “STOCHASTIC NOISE LAYERS”, filed 24 Feb. 2022 (describing examples of application of stochastic layers for data transformation); U.S. Provisional Patent Application 63/313,661, titled “OBFUSCATED TRAINING AND INTERFERENCE WITH STOCHASTIC CONDITIONAL LAYERS,” filed 24 Feb. 2022 (describing application of noise with stochastic conditional layers);; and U.S. Provisional Patent Application 63/311,014, titled QUASI-SYNTHETIC DATA GENERATION FOR MACHINE LEARNING MODELS, filed 16 Feb. 2022 (describing examples of quasi-synthetic data generation which may be used in transforms);each of which is hereby incorporated by reference.

FIG. 4 is a diagram that illustrates an exemplary computing system 400 in accordance with embodiments of the present technique. Various portions of systems and methods described herein, may include or be executed on one or more computer systems similar to computing system 400. Further, processes and modules described herein may be executed by one or more processing systems similar to that of computing system 400.

Computing system 400 may include one or more processors (e.g., processors 410a-410n) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computing system 400 may be a units-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 400 may include a plurality of computing devices (e.g., distributed computer systems) to implement various processing functions.

I/O device interface 430 may provide an interface for connection of one or more I/O devices 460 to computing system 400. I/O devices may include devices that receive input (e.g., from a user) or output information (e.g., to a user). I/O devices 460 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computing system 400 through a wired or wireless connection. I/O devices 460 may be connected to computing system 400 from a remote location. I/O devices 460 located on remote computer system, for example, may be connected to computing system 400 via a network and network interface 440.

Network interface 440 may include a network adapter that provides for connection of computing system 400 to a network. Network interface 440 may facilitate data exchange between computing system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 470 or data 480. Program instructions 470 may be executable by a processor (e.g., one or more of processors 410a-410n) to implement one or more embodiments of the present techniques. Instructions 470 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 420 may include a non-transitory computer readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices).

I/O interface 450 may be configured to coordinate I/O traffic between processors 410a-410n, system memory 420, network interface 440, I/O devices 460, and/or other peripheral devices. I/O interface 450 may perform protocol, timing, or other data transformations to convert data signals from one component (e.g., system memory 420) into a format suitable for use by another component (e.g., processors 410a-410n). I/O interface 450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 400 or multiple computing systems 400 configured to host different portions or instances of embodiments. Multiple computing systems 400 may provide for parallel or sequential processing/execution of one or more portions of the techniques described herein.

Those skilled in the art will appreciate that computing system 400 is merely illustrative and is not intended to limit the scope of the techniques described herein. Computing system 400 may include any combination of devices or software that may perform or otherwise provide for the performance of the techniques described herein. For example, computing system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 400 may be transmitted to computing system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to costs constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing actions A, B, C, and D) encompasses both all such attributes or functions being mapped to all such objects and subsets of the attributes or functions being mapped to subsets of the attributes or functions (e.g., both all processors each performing actions A-D, and a case in which processor 1 performs action A, processor 2 performs action B and part of action C, and processor 3 performs part of action C and action D), unless otherwise indicated. Further, unless otherwise indicated, statements that one value or action is “based on” another condition or value encompass both instances in which the condition or value is the sole factor and instances in which the condition or value is one factor among a plurality of factors. The term “each” is not limited to “each and every” unless indicated otherwise. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In this patent filing, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A system, comprising:
a computing device, comprising:
computational storage or computational memory, the computational storage or computational memory having a processor;
a downstream data processor that is different from the processor of the computational storage or computational memory; and
a bus connecting the processor to the computational storage or computational memory, wherein the computing device comprises a tangible, non-transitory, machine readable medium storing instructions that, when executed, effectuate operations comprising:
receiving an input from a remote device conveyed to the computing device;
determining, based on the input, how to configure a transformation of data stored in the computational storage or computational memory; and
applying, with the processor, the configured transformation to the data stored in the computational storage or computational memory; and
outputting the transformed data to the downstream data processor.

2. The system of claim 1, wherein the downstream data processor is a central processing unit (CPU) of the computing device.

3. The system of claim 1, wherein the remote device corresponds to a cloud service.

4. The system of claim 1, wherein receiving an input message from a remote device comprises receiving a type of transformation.

5. The system of claim 1, wherein receiving an input message from a remote device comprises receiving a strength of transformation.

6. The system of claim 1, wherein the remote device is in communication with the downstream data processor.

7. The system of claim 1, wherein the remote device is not in communication with the downstream data processor.

8. The system of claim 1, further comprising means for obfuscating the data stored in the computational storage or computational memory.

9. The system of claim 1, wherein the computing device is a cloud device.

10. The system of claim 1, the computing device further comprising an input device, wherein the data of the input device is stored in the computational storage or computational memory.

11. The system of claim 1, wherein outputting the transformed data to the downstream data processor comprises outputting the transformed data to an instance of an application.

12. The system of claim 1, wherein outputting the transformed data to the downstream data processor comprises outputting the transformed data to a cloud service.

13. The system of claim 1, wherein computational storage or computational memory comprises encrypted data, and wherein applying the configured transformation comprises de-encrypting at least some of the encrypted data.

14. The system of claim 13, wherein receiving the input from the remote device comprises receiving an encryption key.

15. The system of claim 1, wherein the computational storage or computational memory and the processor comprises a heterogeneously integrated device.

16. The system of claim 1, wherein the transformation comprises a machine learning algorithm.

17. The system of claim 1, wherein the transformation comprises application of one or more layers of a neural network.

18. The system of claim 1, wherein the transformation comprises at least one of sampling, obfuscation, nullification, an identity transformation, a transformation based on data governance, or a combination thereof.

19. The system of claim 1, wherein the downstream data processor further comprises a tangible, non-transitory, machine-readable medium storing instructions that, when executed, effectuate operations comprising:
receiving the transformed data; and
generating an inference based on the transformed data.

20. A tangible, non-transitory, machine readable medium storing instructions that, when executed, effectuate operations comprising:
receiving an input from a remote device conveyed to a computing device;
determining, based on the input, how to configure a transformation of data stored in a computational storage or computational memory; and
applying, with a processor, the configured transformation to the data stored in the computational storage or computational memory; and
outputting the transformed data to a downstream data processor.
